(19) United States
(12) Patent Application Publication
(10) Pub. No.: US 2017/0098017 A1
(43) Pub. Date: Apr. 6, 2017

(54) METHOD FOR EVALUATING GOLF BALL DIMPLE EFFECTS

(71) Applicant: Bridgestone Sports Co., Ltd., Tokyo (JP)

(72) Inventor: Katsunori SATO, Chichibushi (JP)

(73) Assignee: Bridgestone Sports Co., Ltd., Tokyo (JP)

(21) Appl. No.: 15/258,345

(22) Filed: Sep. 7, 2016

(30) Foreign Application Priority Data
Oct. 2, 2015 (JP) 2015-196475

(51) Int. Cl. G06F 17/50; G01M 99/00

(52) U.S. Cl. CPC G06F 17/5009; G01M 99/007

(57) ABSTRACT

A method for evaluating dimple effects on a golf ball includes the steps of: setting up, in a computer, a geometric model representing a dimple that is a concave or convex region and a virtual airflow space which surrounds a periphery of the dimple model; generating a grid in the virtual airflow space and configuring the grid so as to be finer near the dimple model surface and coarser away from the surface; establishing a state where an air stream flows into the virtual airflow space; calculating the momentum thickness in a given plane passing through the dimple; and rating the dimple effects highly when the dimple model has a low momentum thickness. This method directly evaluates the shape of the dimples alone, and thus is simple and can shorten the evaluation time while ensuring good accuracy,

### CROSS-REFERENCE TO RELATED APPLICATION

This non-provisional application claims priority under 35 U.S.C. §119(a) on Patent Application No. 2015-196475 filed in Japan on October 2, 2015, the entire contents of which are hereby incorporated by reference.

### TECHNICAL FIELD

The present invention relates to, when assessing the performance of a golf ball having numerous dimples formed on the surface, a method for evaluating dimple effects which sets up, on a computer, a dimple model and air flow, employs arithmetic operations executed by the computer to analyze air flow over the dimple surfaces, and rates the dimple effects based on the magnitude of air resistance by the dimples alone.

### BACKGROUND ART

It is known that when a physical body such as a golf ball flies through the atmosphere, airflow turbulence arises around the body. If the surface of the body has a complex shape or the body rotates while in flight, airflow turbulence during flight becomes complex and exerts a major influence on the flight performance, such as flight distance, of the body.

Golf balls are usually provided with a large number of dimples of circular shape, as seen from above. Because the combination of dimple parameters such as three-dimensional shape, arrangement and size has a major influence on the aerodynamic properties of the golf ball, it is necessary to understand the causal relationship between these dimple parameters and the aerodynamic properties.

Generally, when investigating the effects that changes in dimple parameters such as shape, construction and arrangement have on the flight performance of a golf ball, it has commonly been the practice to fabricate a variety of golf ball molds and test-produce various golf balls. The balls are then subjected to ball striking tests and properties such s as initial velocity, spin rate and trajectory (flight distance, height) are measured, from which the aerodynamic properties are evaluated.

However, such experimental evaluation based on actual physical prototypes is time-consuming and costly, and moreover cannot clearly establish causal relationships between the shapes and arrangement of the dimples and the aerodynamic properties of the ball. For this reason, golf balls which have been newly designed based on evaluation results obtained by experimentation often fail to achieve the intended performance. in such cases, it is necessary each time to design and produce a new ball prototype and determine its aerodynamic properties, generating a further outlay of time and expense, and thus making efficient golf ball development impossible.

To address this problem, the inventor earlier proposed a simulation method which sets up, in a computer, a golf ball model and a virtual airflow space surrounding the periphery of the golf ball model, establishes a state where an air stream flows into the virtual airflow space, calculates the coefficients of lift and drag for the golf ball and, based on these calculated values, estimates the trajectory of the golf ball when it is hit (JP-A 2006-275722; U.S. Pat. No. 7,435,089), The inventor also proposed a simulation method for evaluating golf balls which improves upon the foregoing simulation method by simplification without lowering accuracy and is thus able to effectively shorten the computational time. (JP-A 2012-061309).

However, when evaluating the performance of a golf ball by these simulation methods, to calculate the coefficients of lift and drag, a grid is generated within the virtual airflow space, the grid being set up so as to be finer near the surface of the golf ball model and to become larger at an increasing distance from the surface. The velocity, direction and pressure of the air stream are calculated for each cell of the grid and integrated, by means of which the coefficients of lift and drag are calculated. Evaluating golf ball performance by such a simulation method takes a very long time, and so is lacking in feasibility and practicality.

Hence, there has existed a desire for a method of evaluating dimple effects that can be carried out simply and in a relatively short time by establishing a method which, instead of evaluating the aerodynamic properties of the ball in order to calculate the coefficients of lift and drag, evaluates the dimples themselves alone.

Related art is described in JP-A 2006-275722, U.S. Pat. No. 7,435,089, JP-A 2012-061309, JP-A 2002-358473, JP-A 2005-034378, JP-A 2002-340735, JP-A 2002-250739 and 35-A 2011-227869.

### SUMMARY OF THE INVENTION

It is therefore an object of this invention to provide a method for evaluating dimple effects, which method evaluates the aerodynamic performance of the dimples alone without calculating the golf ball coefficients of lift and drag, and can be carried out simply and in a relatively short time without lowering accuracy.

Accordingly, this invention provides a method for evaluating golf ball dimple effects by analyzing air flow near a surface of the dimple, which method includes the steps of:
(I) setting up, within a virtual space created in a computer, a geometric model representing a dimple that is a concave or convex region and a virtual airflow space which surrounds a periphery of the dimple model;
(II) generating a grid in the virtual airflow space and configuring the grid so as to be finer near a surface of the dimple model and to gradually increase in size in a direction leading away from the surface;
(III) establishing a state where an air stream of a given velocity flows into the virtual airflow space from in front of the dimple model;
(IV) letting a main direction of flow by the air stream within the virtual airflow space be the x-direct ion, a base direction of the dimple model he the y-direction, and a direction perpendicular to both the airstream main flow s direction and the dimple model base direction be the z-direction, setting up an x-y plane that passes through the dimple and calculating the momentum thickness θ; and
(V) when the dimple model has a low momentum thickness θ, treating the model as having a low air resistance and rating the dimple effects highly.

In a preferred embodiment of the inventive method of evaluation, the geometric model is a model having at least two convex or concave regions representing dimples set on a flat plane (base).

In another preferred embodiment, the geometric model represents a dimple that is a convex or concave region on a hemispherical surface representing a ball.

The concave or convex region representing a dimple may have a contour shape that is circular or non-circular.

A plurality of concave or convex regions representing dimples may be arranged in series with respect to the main direction of flow by the air stream (x-direction).

The concave or convex regions representing dimples may number three or more and be arranged in parallel with respect to the main direction of flow by the air stream.

In another embodiment of the evaluation method of the invention, when setting up an x-y plane passing through the dimple and calculating the momentum thickness θ, the dimple is evaluated by calculating the momentum thickness in an x-y plane passing through the center or near the center of the dimple.

In yet another embodiment of the inventive method, when setting up an x-y plane passing through the dimple and calculating the momentum thickness θ, the dimple is evaluated based on the average of the momentum thicknesses in x-y planes at two or more places in the z-direction.

In still another embodiment, when setting up an x-y plane passing through the dimple and calculating the momentum thickness θ, the dimple is evaluated based on the average of the momentum thicknesses in x-y planes at three or more places.

The dimple may be evaluated by varying at least one condition selected from the group consisting of the contour shape, area, depth, cross--sectional shape and volume of the concave or convex region representing a dimple.

### ADVANTAGEOUS EFFECTS OF THE INVENTION

The inventive method of evaluation, because it does not require testing and evaluation with physical prototypes, such as in a wind tunnel test, and because there is no need to analyze air flow around a golf ball rotating in flight and calculate the coefficients of lift and drag for the golf ball, is simple and enables the evaluation time to be shortened. Moreover, this invention, in which dimples alone are the direct object of evaluation, uses a specific method to analyze the airflow state at dimple surfaces in a computerized simulation and evaluate the dimple effects, and is thereby able to accurately evaluate the aerodynamic properties of the dimples.

### BRIEF DESCRIPTION OF THE DIAGRAMS

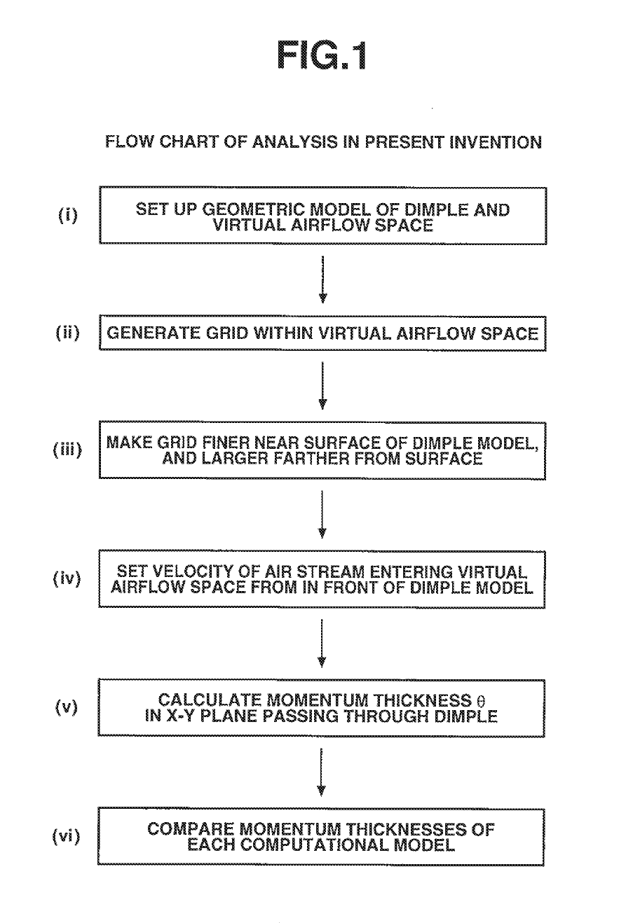

FIG. 1 is a flow chart showing an analytical procedure for evaluating dimple effects by analyzing the air stream at dimple surfaces in the inventive method of evaluation.

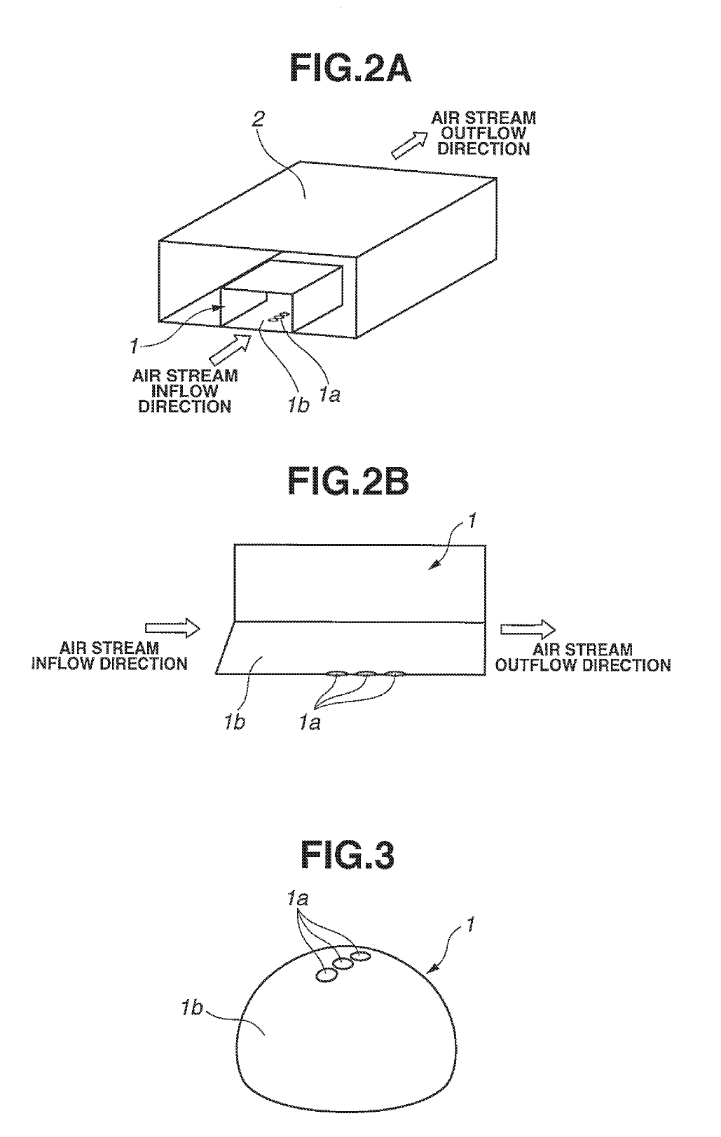

FIGS. 2A and 2B are explanatory diagrams showing the geometric dimple model and virtual airflow space according to one embodiment of the inventive method of evaluation in which concave or convex regions representing dimples on a flat plane (base) are used as the dimple model.

FIG. 3 is an explanatory diagram showing the geometric dimple model and virtual airflow space according to another embodiment of the inventive method of evaluation in which concave or convex regions representing dimples on a hemispherical surface representing a ball are used as the dimple model.

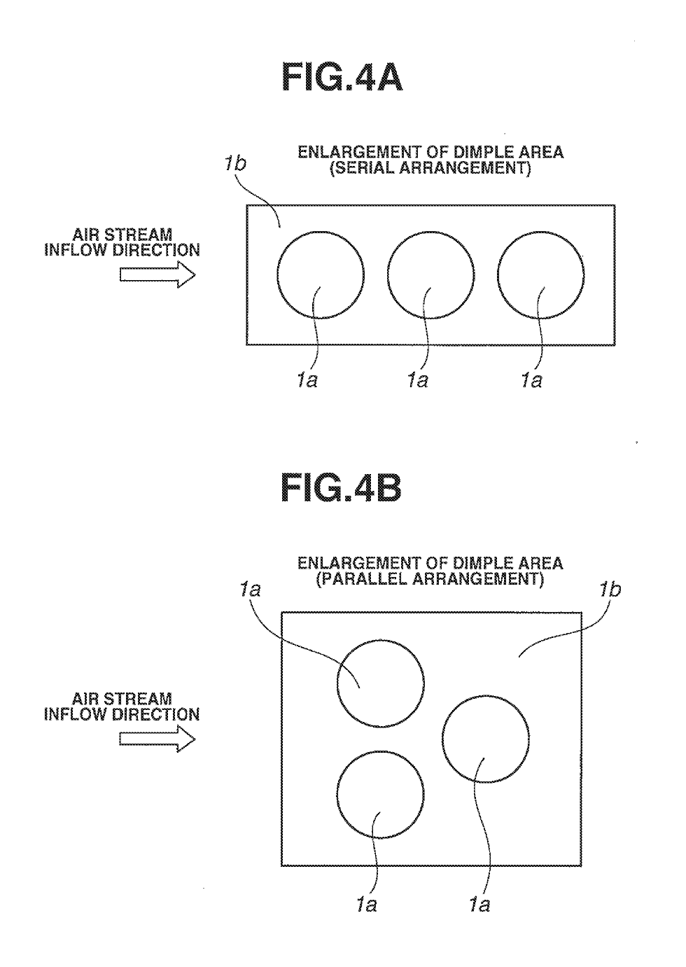

FIGS. 4A and 4B are enlarged plan views showing example arrangements of convex or concave regions representing dimples.

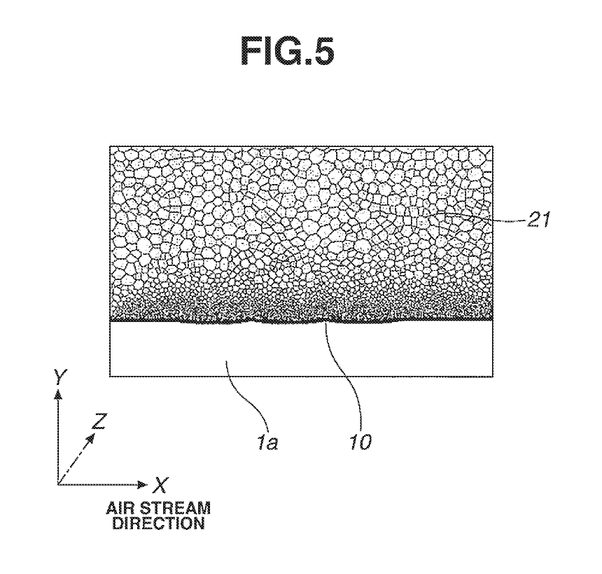

FIG. 5 shows a cross-section passing through the center of a geometric dimple model, this being an enlarged schematic view of the surface and surface vicinity of the dimple model.

### DESCRIPTION OF THE PREFERRED EMBODIMENTS

The objects, features and advantages of the invention will become more apparent from the following detailed description, taken in conjunction with the foregoing diagram.

The inventive method for evaluating dimple effects uses a geometric dimple model having at least one concave or convex region formed on a surface to analyze air flow at the periphery of the surface, calculates the subsequently described momentum thickness θ and, when the dimple model has a low momentum thickness, treats it as having a low air resistance and rates the dimple effect highly.

In the evaluation method of the invention, first (A) geometric model representing a dimple that is a convex or concave region and a virtual airflow space surrounding the periphery of the dimple model are set up within a virtual space created in a computer (step (i) in the flow chart in FIG. 1).

FIGS. 2 and 3 show examples of this step of setting up a geometric dimple model and a virtual airflow space by computer. FIG. 2 includes a schematic perspective view of an embodiment in which a geometric dimple model and a virtual airflow region are set up within a virtual space. This model 1 is in the form of a box (rectangular cuboid; also referred to below simply as a “cuboid”), and uses convex or concave regions 1a representing dimples on a flat plane (base) 1b. FIG. 3 is an enlarged perspective view of an embodiment in which the model uses concave or convex regions 1a representing dimples on a hemispherical surface 1b representing a ball.

As shown in FIG. 2A, in this geometric dimple model 1, a plurality of dimples (concave or convex regions) la are set on the base lb of a small rectangular cuboid. Were the concave or convex regions la to be set on the top of the s dimple model 1 that is a box (cuboid), it would be necessary to take into account the influence of the side wall or edge on the air stream inflow direction side of the cuboid, as a result of which the number of unnecessary and pointless calculations and condition settings would end up increasing. To avoid external factors as much as possible and thus facilitate analysis and calculations, the dimples are set on the base of the cuboid. With regard to the depth of the dimples, because the dimple model 1 is set within a virtual space 2 as shown in FIGS. 2A and B, owing to the arrangement of these two boxes (cuboids), the depth of the dimples set on the base also is taken into consideration when carrying out analysis and calculations on specific dimples.

In cases where concave or convex regions 1a representing dimples are used on a hemispherical surface 1b as shown in FIG. 3, unlike the embodiment in FIG. 2, the influence of air flow from in front of the hemispherical surface 1b is taken into consideration when carrying analysis and calculations on specific dimples.

In the invention, as noted above and shown in FIG. 2A, for example, a geometric dimple model 1 and a virtual airflow space 2 surrounding the periphery of the model 1 are set up within a virtual space. The dimple model 1 may be created by 3D CAD, for example. The virtual airflow space 2 may be given a cuboid shape of a given size with the dimple model 1 at the center. In FIG. 2, two cuboidal spaces are created: a small cuboid on the inside, and an outside cuboid. As subsequently described, a grid is finely formed in the virtual airflow space. By having the range over which this grid is finely formed serve as the interior of the small inside cuboid, it is possible to suitably control the grid size at the interior of this cuboid, enabling the analysis operations to be carried out smoothly and efficiently in a short time. It is essential for this virtual airflow space 2 to be given a range having the size of the air stream that exerts an influence on the dimple surfaces. The air stream at a distance from the dimple surfaces has only a small influence on the dimples; on the other hand, the accuracy of dimple effect simulation tends to decrease when the size of the virtual airflow space is too small. For this reason, the size of the virtual airflow space 2 may be suitably selected while also taking into consideration the efficiency or accuracy of simulation.

In the geometric dimple model, the number of concave or convex regions representing a dimple may be one or may be a plurality; preferably, this number is set to at least two. It should be noted, however, that when the number of concave or convex regions becomes larger, the time is takes to analyze airflow at the surface portions of the concave or convex regions increases, which becomes impractical.

In FIG. 4A, three concave or convex regions 1a are arranged serially in the air stream inflow direction. By thus serially arranging a plurality of concave or convex regions 1a and observing, through continuous and fine-grained simulation, airflow changes at the surface portions of the concave or convex regions 1a (dimples) in the x-direction, dimple evaluation using a geometric dimple model in a state that approximates the movement of a golf ball having numerous dimples arranged on the surface is possible.

Alternatively, as shown in FIG. 4B, it is also possible to have the number of concave or convex regions simulating dimples be three or more and to arrange these concave or convex regions in parallel with respect to the main direction of flow by the air stream. In this case, by observing also, through continuous and fine-grained simulation, airflow changes at the surface portions of the concave or convex regions 1a (dimples) in the z-direction, which is a direction perpendicular to both the main direction of flow by the air stream and the base direction of the geometric dimple model, dimple evaluation using a dimple model in a state that approximates the movement of a golf ball having numerous dimples arranged on the surface is possible.

The contour shapes of the concave or convex regions representing dimples may be circular or non-circular.

Next, (II) a grid is generated in the virtual airflow space, and the grid is set up so as to be finer near a surface of the dimple shape model and to gradually increase in size in a direction leading away from the surface (steps (ii) and (iii) in the flow chart in FIG, 1).

Specifically, the concave or convex regions 1a within the geometric dimple model 1 are divided into cells measuring, for example, about 0.002 mm on a side, thereby setting up a large number of polygonal (e.g., triangular, quadrangular) or substantially polygonal (e.g., substantially triangular, substantially quadrangular) face cells. In addition, as shown in FIG. 5, grid cells 21 adjoining the surface 10 of the concave or convex region 1a within the dimple model 1 which is entirely covered by these individual face cells are set up. The grid cells 21 adjoining the surface 10 of the concave or convex region 1 are set up in substantially polygonal prismatic shapes such as substantially quadrangular prismatic shapes, or in substantially polygonal pyramidal shapes. Also, from the grid cells adjoining the surface 10 of the concave or convex region 1a, the remainder of the virtual airflow space 2 is divided grid-like into cells in such a way that the volume of the grid cells 21 gradually increases in directions leading away from the dimple model 1. In this way, the entire virtual airflow space 2 is divided into grid cells 21.

The grid cells formed in the virtual airflow space 2 may be given suitable three-dimensional shapes, such as those of a polygon mesh (polyhedrons), a tetra mesh (tetrahedrons), a prism mesh (triangular prisms), a hexa mesh (hexahedrons), or any shape that is a mixture thereof, Of the above, the use of a polygon mesh geometry or a tetra mesh geometry is especially preferred.

Because the air stream that exerts an influence on the dimple surface has a greater influence when close to the golf ball, as shown in FIG. 5 and explained above, the grid cells are set up in such a way as to be finer near the concave or convex region 1a of the geometric dimple model 1 and to be coarser away from the concave or convex region 1a where the influence exerted by the air stream is small. The increase in the volume of the grid cells in directions leading away from the surface of the concave or convex regions 1a in the dimple model 1 may be continuous or stepwise.

Next, (III) a state where an air stream of a given velocity flows into the virtual airflow space 2 from in front of the geometric dimple model 1 is established (step (iv) in the flow chart in FIG. 1).

The velocity of the air stream is not subject to any particular limitation and may be suitably set in accordance with, for example, the anticipated velocity of flight by the golf ball. Generally, the air stream velocity may be set to any velocity within a range of from 5 to 90 m/s.

Next, letting a main direction of flow by the air stream within the virtual airflow space be the x-direction, a base direction of the geometric dimple model be the y-direction, and a direction perpendicular to both the airstream main flow direction and the dimple model base direction be a z-direction, an x-y plane that passes through the dimple is set up and the momentum thickness θ is calculated (step (v) in the FIG. 1 flow chart).

That is, the elements of motion that arise when an air stream flows into the virtual airflow space 2 and comes into contact with a concave or convex region 1a within the geometric dimple model 1 are the velocity of the air stream in each axial direction in a three-dimensional spatial coordinate system, the direction of the air stream, and the pressure of the air stream against the surface of the dimple model 1. These elements of motion can be calculated by substituting numerical values into the basic equations used for computation; namely, the equations of continuity (1) to (3) below corresponding to the law of conservation of mass, and the Navier-Stokes equations (4) to (6) below corresponding to the law of conservation of momentum by a physical body.

In a simulation where, as shown in FIGS. 2A and B, air flows in the direction of the arrows at the surface of concave or convex regions 1a within the above geometric dimple model 1, the flow of air in each of the grid cells in the virtual airflow space 2 may be analyzed by arithmetic operations. Using the above equations (1) to (6) for the arithmetic operations, equations (1) to (6) can be discretized for the virtual airflow space 2 that has been partitioned into grid cells, and the operations carried out. The method of simulation used may be suitably selected from among, for example, finite difference calculus, finite volume methods, boundary element methods and finite element methods while taking parameters such as the simulation conditions into account.

$$\begin{matrix}\frac{\partial ρ}{\partial t} + \frac{\partial ( ρ u )}{\partial x} + \frac{\partial ( ρ v )}{\partial y} + \frac{\partial ( ρ w )}{\partial z} = 0 & ( 1 ) \\ divV = \frac{\partial ( ρ u )}{\partial x} + \frac{\partial ( ρ v )}{\partial y} + \frac{\partial ( ρ w )}{\partial z} & ( 2 )\end{matrix}$$

where u, v and w are the velocities in the x, y and z directions, respectively.

Using the divergence operator,

$$\frac{\partial ρ}{\partial t} + div ( ρ V ) = 0. \qquad ( 3 )$$

Letting F be the mass force,

$$\begin{matrix}\frac{Du}{Dt} = {F}_{x} - \frac{1}{ρ} \frac{\partial ρ}{\partial x} + \frac{μ}{ρ} ( \frac{{\partial }^{2} u}{\partial {x}^{2}} + \frac{{\partial }^{2} u}{\partial {y}^{2}} + \frac{{\partial }^{2} u}{\partial {z}^{2}} ) + \frac{1}{3} \frac{μ}{ρ} \frac{\partial }{\partial x} ( \frac{\partial u}{\partial x} + \frac{\partial v}{\partial y} + \frac{\partial w}{\partial z} ) & ( 4 ) \\ \frac{Dv}{Dt} = {F}_{y} - \frac{1}{ρ} \frac{\partial ρ}{\partial y} + \frac{μ}{ρ} ( \frac{{\partial }^{2} v}{\partial {x}^{2}} + \frac{{\partial }^{2} v}{\partial {y}^{2}} + \frac{{\partial }^{2} v}{\partial {z}^{2}} ) + \frac{1}{3} \frac{μ}{ρ} \frac{\partial }{\partial x} ( \frac{\partial u}{\partial x} + \frac{\partial v}{\partial y} + \frac{\partial w}{\partial z} ) & ( 5 ) \\ \frac{Dw}{Dt} = {F}_{z} - \frac{1}{ρ} \frac{\partial ρ}{\partial z} + \frac{μ}{ρ} ( \frac{{\partial }^{2} w}{\partial {x}^{2}} + \frac{{\partial }^{2} w}{\partial {y}^{2}} + \frac{{\partial }^{2} w}{\partial {z}^{2}} ) + \frac{1}{3} \frac{μ}{ρ} \frac{\partial }{\partial z} ( \frac{\partial u}{\partial x} + \frac{\partial v}{\partial y} + \frac{\partial w}{\partial z} ) & ( 6 )\end{matrix}$$

where ρ is the air density, p is the air pressure, and μ is the air viscosity.

Next, in this invention, the momentum thickness θ is calculated from numerical data for air stream velocity in the respective axial directions of a three-dimensional space coordinate system, air stream direction and air stream pressure on the surface of the concave or convex region 1a that are calculated from (1) to (6) above.

$$θ = \frac{1}{{U}^{2}} {\int }_{0}^{∞} u ( U - u ) d y$$

where θ is the momentum thickness, and U is the main flow velocity.

At the dimple surface and in the vicinity thereof, i.e., in a thin-layer region extremely close to the dimple surface, the influence of viscosity becomes pronounced, the velocity gradient du/dv becomes very large, and large frictional shear stresses act on the flow. The thin layer such as this along the surface of a physical body is called a “boundary layer.” By distinguishing between the boundary layer that lies along the surface of the body and has a large velocity gradient and the main flow to the outside thereof, the flow field can be divided up into a region exhibiting the properties of a viscous fluid and a region exhibiting the properties of an ideal fluid, and examined, Letting “u” be the velocity of the ultrathin layer close to the wall of the body and letting the symbol U represent the velocity of the overall layer outside of this ultrathin layer, referred to as the main flow velocity, the boundary layer thickness δ is often defined as the position where u=0.99U. Also, because the momentum (mass×velocity) within the boundary layer decreases more than in the flow of an ideal fluid, taking note of this loss, the momentum thickness θ is a physical quantity created with the idea of making the momentum per unit time when passing through a region of thickness θ at a velocity U equal to the loss of momentum in the actual boundary layer. The term u(U-u) in the above formula corresponds to the loss of momentum in the boundary layer.

The smaller this momentum thickness θ value, i.e., the closer it approaches to zero, the smaller the loss of momentum near the dimple surface, i.e., within the boundary layer. This result, by signifying a low air resistance, enables the dimple effects to be highly rated.

In step (v) of the flow chart in FIG. 1, as described above, letting a main direction of flow by the air stream within the virtual airflow space be the x-direction, a base direction of the geometric dimple model be the y-direction, and a direction perpendicular to both the airstream main flow direction and the dimple model base direction be the z-direction, an x-y plane that passes through the dimple is set up and the momentum thickness θ is calculated. The significance of setting up an x-y plane that passes through the dimple is to observe changes in momentum acting on the dimple in this plane. Here, in setting up an x-y plane that passes through the dimple, it is preferable to set the x-y plane so as to pass through the center or near the center of the dimple, and calculate the momentum thickness in this plane. The reason is that, at or near the center of the dimple, the change in the momentum acting on the dimple is large. When setting up an x-y plane passing through the dimple and calculating the momentum thickness θ, the dimple may be evaluated based on the average of the momentum thicknesses determined in x-y planes at three or more places. Selecting such a means has the advantage of enabling changes in momentum due to the dimple to be more accurately expressed.

In order to even more accurately analyze and evaluate the change in momentum due to a dimple, when setting up an x-y plane passing through the dimple and calculating the momentum thickness θ, the dimple may be evaluated based on the average of the momentum thickness in x-y planes at two or more places in the z-direction.

After having set up the x-y plane and calculated the momentum thickness θ, as shown in step (vi) in the flow chart of FIG. 1, the momentum thicknesses for each computational model can he compared. That is, first a dimple shape that serves as a reference is established, the momentum thickness of this dimple shape is compared with the momentum thicknesses of the dimple shapes in each of the working examples, and evaluations of the relative aerodynamic performances of each of the dimples can be carried out. For example, letting the momentum thickness in this reference dimple be an arbitrary value of 100, the measured momentum thicknesses of concave or convex regions (dimples) within the respective geometric dimple models can be expressed exponentially. As explained above, the lower the momentum thickness, the smaller the air resistance, and so the effects of concave or convex regions (dimples) within the geometric dimple model are more highly rated.

Because the combination of the three-dimensional shape, arrangement, size and other parameters of the dimples exerts an influence on the aerodynamic properties, the dimple effects can be continuously or collectively evaluated by suitably varying at least one parameter (condition) selected from the group of parameters in the concave or convex regions representing dimples—these parameters being the contour shape, area, depth, cross-sectional shape and volume. By thus varying at least one dimple parameter, it is possible to more concretely understand the relationship between the dimple parameters and the aerodynamic properties and thereby provide specific dimples on the surface of a golf ball in such a way as to obtain the desired aerodynamic properties.

Hence, the inventive method of evaluation does not require testing and evaluation with physical prototypes, such as in a wind tunnel test, and obviates the need to analyze air flow around a golf ball rotating in flight and calculate the coefficients of lift and drag for the golf ball. This method, which is premised on the use of dimples alone as the direct object of evaluation, is able, as described above, to evaluate dimple effects by analyzing the airflow state at the surface of dimples in a computerized simulation.

### EXAMPLES

The following Working Examples of the invention and Comparative Examples are provided to illustrate the invention, and are not intended to limit the scope thereof.

### Examples 1 to 3, Comparative Example

In Examples 1 to 3 and the Comparative Example (reference), each of which had a different dimple design, based on the dimple model shown in FIG. 2, the momentum thickness θ was calculated under the conditions shown in Table 1 below using a computer, and the dimple effects were evaluated.

TABLE 1

| | | Com- | | | |
|---|---|---|---|---|---|
| | | parative | | | |
| | | Example | | Exam- | Exam- |
| | | (reference) | Example 1 | ple 2 | ple 3 |
| Details | Contour | circular | circular | circular | circular |
| of concave | Diameter (mm) | 4.0 | 4.0 | 4.0 | 4.0 |
| or convex | Depth (mm) | 0.150 | 0.135 | 0.145 | 0.165 |
| regions | Cross-sectional | circular | circular | circular | circular |
| (dimples) | shape | arc | arc | arc | arc |
| in dimple | Volume (mm³) | 0.944 | 0.850 | 0.913 | 1.039 |
| model | Arrangement | 2 in | 2 in | 2 in | 2 in |
| | | series | series | series | series |

| | | | | |
|---|---|---|---|---|
| Grid shape | polygon | polygon | polygon | polygon |
| | mesh | mesh | mesh | mesh |
| Airflow velocity | 72 | 72 | 72 | 72 |
| (main flow velocity) U (m/s) | | | | |
| Measurement cross-section | Z = 0 | Z = 0 | Z = 0 | Z = 0 |
| Momentum thickness θ (mm) | 0.030 | 0.020 | 0.025 | 0.040 |
| Data comparison | — | Excellent | Good | NG |

From the results in the table, the momentum thickness θ in Example 1 was thin relative to the Comparative Example (reference), leading to an assessment of low air resistance.

The momentum thickness θ in Example 2 was somewhat thin relative to the Comparative Example (reference), leading to an assessment of a somewhat low air resistance.

The momentum thickness θ in Example 3 was somewhat thick relative to the Comparative Example (reference), leading to an assessment of high air resistance.

The dimple shape evaluations were thus as follows, in order of desirability: Example 1>Example 2>Example 3.

Japanese Patent Application No. 2015-196475 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A method for evaluating golf ball dimple effects by analyzing air flow near a surface of a golf ball dimple, comprising the steps of
(I) setting up, within a virtual space created in a computer, a geometric model representing a dimple that is a concave or convex region and a virtual airflow space which surrounds a periphery of the dimple model;
(II) generating a grid in the virtual airflow space and configuring the grid so as to be finer near a surface of the dimple model and to gradually increase in size in a direction leading away from the surface;
(III) establishing a state where an air stream of a given velocity flows into the virtual airflow space from in front of the dimple model;
(IV) letting a main direction of flow by the air stream within the virtual airflow space be the x-direction, a base direction of the dimple model be the y-direction, and a direction perpendicular to both the airstream main flow direction and the dimple model base direction be the z-direction, setting up an x-y plane that passes through the dimple and calculating the momentum thickness θ; and
(V) when the dimple model has a low momentum thickness θ, treating the model as having a low air resistance and rating the dimple effects highly.

2. The evaluation method of claim 1 wherein the geometric model is a model having at least two concave or convex regions representing dimples set on a flat plane (base).

3. The evaluation method of claim 1, wherein the geometric model represents a dimple that is a concave or convex region on a hemispherical surface representing a ball.

4. The evaluation method of claim 1, wherein the concave or convex region representing a dimple has a contour shape that is circular or non-circular.

5. The evaluation method of claim 1, wherein a plurality of concave or convex regions representing dimples are arranged in series with respect to the main direction of flow by the air stream (x-direction).

6. The evaluation method of claim 1, wherein the concave or convex regions representing dimples number three or more and are arranged in parallel with respect to the main direction of flow by the air stream.

7. The evaluation method of claim 1 wherein, when setting up an x-y plane passing through the dimple and calculating the momentum thickness θ, the dimple is evaluated by calculating the momentum thickness in an x-y plane passing through the center or near the center of the dimple.

8. The evaluation method of claim 1 wherein, when setting up an x-y plane passing through the dimple and calculating the momentum thickness θ, the dimple is evaluated based on the average of the momentum thicknesses in x-y planes at two or more places in the z-direction.

9. The evaluation method of claim 1 wherein, when setting up an x-y plane passing through the dimple and calculating the momentum thickness θ, the dimple is evaluated based on the average of the momentum thicknesses in x-y planes at three or more places.

10. The evaluation method of claim 1 wherein the dimple is evaluated by varying at least one condition selected from the group consisting of the contour shape, area, depth, cross-sectional shape and volume of the concave or convex region representing a dimple.
